(19) United States
(12) Patent Application Publication
(10) Pub. No.: US 2003/0011489 A1
(43) Pub. Date: Jan. 16, 2003

(54) Full duplex discrete multi-tone modulation for use in oil field well logging applications

(75) Inventor: Raman Viswanathan, Houston, TX (US)

Correspondence Address: PAUL S MADAN, MADAN, MOSSMAN & SRIRAM, PC, 2603 AUGUSTA, SUITE 700, HOUSTON, TX, 77057-1130, US

(73) Assignee: Baker Hughes, Inc.

(21) Appl. No.: 10/172,640

(22) Filed: Jun. 14, 2002

Related U.S. Application Data
(60) Provisional application No. 60/299,275, filed on Jun. 19, 2001.

(51) Int. Cl. G01V 3/00

(52) U.S. Cl. 340/853.1; 340/855.7

(57) ABSTRACT

A communication protocol based upon the Asymmetric Digital Subscriber Line (ADSL) protocol developed for telephone communications is used for two way transmission of data between a downhole logging device and a surface device. The total available bandwidth for a pair of conductors is determined by the length of the conductors and the choice of conductors (operational mode) of a conventional 7 conductor wireline. The available bandwidth is partitioned into channels with a bandwidth of 4.3125 kHz, each of the channels carrying a portion of the data. A contiguous subset of the channels is used for downward communication and another subset is used for upward communication. The bit loading is dynamically determined based upon monitoring of the noise level. Optionally, more than one mode of the 7 conductor wireline may be used.

### REFERENCES TO RELATED DOCUMENTS

This application claims priority from U.S. Provisional Patent Applications Ser. No. 60/299,275 filed on Jun. 19, 2001

### BACKGROUND OF THE INVENTION

1. Field of the Invention

The present invention is related to the field of electric wireline well logging tools. More specifically, the present invention is related to systems for two way communication of signals between logging tools disposed in wellbores and a recording and control system located at the earth's surface

2. Background of the Art

Electric wireline well logging tools are used to make measurements of certain properties of earth formations penetrated by wellbores. The measurements can assist the wellbore operator in determining the presence, and quantity if present, of oil and gas within subterranean reservoirs located within the earth formations.

Well logging tools known in the art are typically extended into the wellbore at one end of an armored electrical cable. The cable can includes at least one, and commonly includes as many as seven, insulated electrical conductors surrounded by steel armor wires. The armor wires are included to provide abrasion resistance and tensile strength to the cable also provide the mechanical strength to suspend logging instruments in the borehole. The cable supplies electrical power to the logging tools and provides a communication channel for signals sent between the logging tools and a recording system usually located near the wellbore at the earth's surface.

Logging tools known in the art can provide many different types of measurements of the earth formation properties, including measurements of electrical resistivity, natural gamma-ray radiation intensity, bulk density, hydrogen nucleus concentration and acoustic travel time, among others. Still other logging tools, generally called “imaging” tools, provide finely detailed measurements, meaning successive measurements can be made at axial and radial spacings of as little as several hundredths of an inch, of resistivity and acoustic pulse-echo travel time in order to generate a graphic representation of the visual appearance of the wall of the wellbore.

It is generally beneficial to the wellbore operator to be able to combine as many different types of logging tools as is practical into one continuous instrument package (generally called a “tool string” by those skilled in the art). The benefit to the operator is to reduce the number of times logging tools must be extended into the wellbore, which can save a considerable amount of operating time. Combining a large number of measurements generally requires that large amounts of signal data be sent to the recording system at the earth's surface.

A particular problem in combining large numbers of measurements in the tool string is that the large amount of signal data which must be transmitted can cause the required signal data transmission rates to exceed the signal carrying capacity of the cable. This problem is particularly acute when the imaging tools are included in the tool string because of the very fine measurement spacing, and consequently the large increase in the amount of signal data, of imaging tools relative to other types of tools.

FIGS. 1a-1f show cross-sections of commonly used logging wirelines, the most common being the 7 conductor cable of FIG. 1a. The existing cables are designed for the mechanical strength and not optimized for signal transmission. Present well logging instruments employing advanced technology generate large amount of data. Large investments are in place to support the present cables. The cable may have limited signal transmission capacity because it is designed for mechanical strength not signal transmission capability. Typical bandwidth of a 30000-ft. multiconductor cable is less than 200 kHz.

U.S. Pat. No. 5,838,727 to Lyon et al. discloses a Quadrature Amplitude Modulation (QAM) method for increasing the data transmission capability of a conventional cable. Combined amplitude and phase modulation (quadrature amplitude modulation) is applied to the digital data and the sampled digital waveform converted to an analog waveform for passage over the bandpass channel. The sample rate is chosen as an integer multiple of the symbol rate and carrier frequency to significantly reduce processing overhead. Reception of the acquired data is similar to transmission and involves an analogous amplitude and phase demodulation. A drawback to QAM when used in wireline well logging tool signal telemetry is that precise recovery of the data signal impressed onto the carrier requires a complex and expensive signal demodulator to precisely recover the amplitude and phase of the carrier. It can be impractical to provide such a demodulator for use in wireline recording systems.

U.S. Pat. No. 5,473,321 to Goddman et al teaches the use of an adaptive telemetry system for communication of logging data through a conventional cable. The telemetry system used therein employs a periodic pseudo-random training sequence to effectively initialize an adaptive digital FIR filter-equalizer for optimal communications between a surface modem and downhole measuring equipment, without requiring any changes to the normal logging configuration or any special operator intervention. In a “training mode”, an electronic source in a downhole sonde transmits a predetermined training sequence to a surface modem via a cable. The source preferably transmits the training sequence continuously until the surface modem has acclimated itself to the characteristics of the multiconductor cable by adaptively configuring the filter-equalizer, thereby enabling the surface modem to accurately interpret data received from the sonde despite attenuation, noise, or other distortion on the cable. The filter-equalizer adjusts itself in response to an error signal generated by comparing the filter-equalizer's output with a similar training sequence provided by a training generator. After the surface modem is trained, the system operates in an “operational mode,” in which the sonde transmits data corresponding to downhole measurements, and the filter-equalizer's error signal is generated by comparing the filter-equalizer's output to a sliced version of the filter-equalizer's output. In this mode, the filter-equalizer continually adjusts itself to most accurately receive and interpret the data. Like QAM, this adaptive method requires complicated electronic circuitry at both ends.

Both the QAM methods and the adaptive telemetry methods result in increased data transmission capability. The 7 conductor cable of FIG. 1a can be used in one of several modes as indicated in FIG. 2. For example, in the so-called mode 2, conductors 2 and 3 are used in conjunction with conductors 5 and 6; mode 5 uses conductors 2 and 5 in conjunction with conductors 3 and 6, while mode 7 uses the conductor 7 in conjunction with conductors 1,2,3,4,5 and 6. The attenuation characteristics of a cable of a length 30000-ft. are shown in FIG. 3. As expected, the higher the frequency, the greater the attenuation.

Conventional cables are used for two-way transmission of signals in addition to supplying power to the downhole logging tool assembly. The upward communication comprises the data recorded by the individual logging tools while the downward communication comprises control commands to the logging tools. The control commands may include instructions for setting the parameters used in the tools. Prior art devices rely on the half-duplex mode wherein at any one time, only one way communication is possible. Consequently, either one-way communication is used with each of the modes discussed above and shown in FIG. 2, or else the modes have to be switched from upwards to downwards transmission as necessary. This is inefficient and leads to a decrease in the total throughput of the communications links.

It would be desirable to have a method of two-way downhole communication. Such a method should preferable be compatible with existing wirelines to avoid the enormous cost of replacing the wirelines. The present invention satisfies this need.

### SUMMARY OF THE INVENTION

The present invention is a method for simultaneous two-way communication between a downhole logging device used in formation evaluation and an uphole device through a cable. In a preferred embodiment, the cable is a seven conductor cable with multiple modes of possible data transmission. For any particular mode, the total available bandwidth is partitioned into a plurality of channels. A contiguous subset of the channels is used for transmitting data from the surface and another (larger) contiguous subset of channels is used for transmitting data from the logging device.

In a preferred embodiment of the invention, the bit loading on the channels is dynamically changed based upon the noise levels in the channels. Each channel has the capacity of a V.34 modem. Appropriate protocol is included in the invention for initialization and also for dealing with periods when there is no data transmission.

### BRIEF DESCRIPTION OF THE DRAWINGS

FIGS. 1a-1f (Prior Art) show cross-sections of commonly used wirelines for logging applications.

FIG. 2 (Prior Art) shows examples of the modes of operation of a seven conductor wireline.

FIG. 3 shows the attenuation characteristics of some of the modes of operation of a seven conductor wireline.

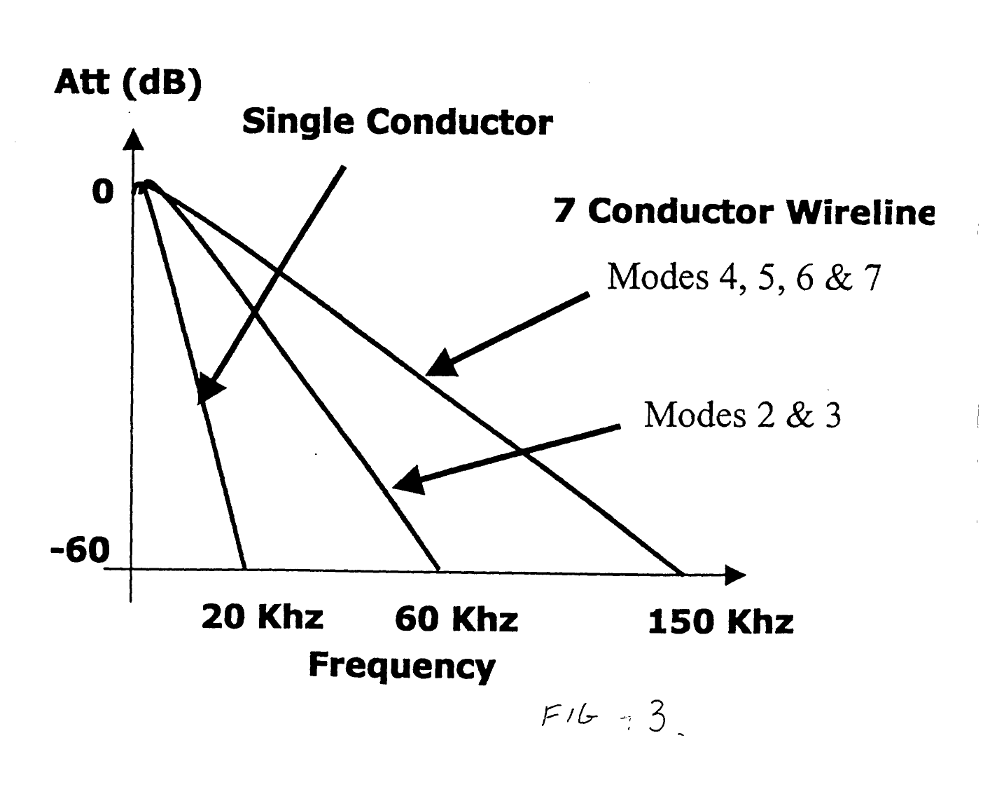

FIG. 4 (Prior Art) shows a well logging tool lowered into a wellbore penetrating an earth formation.

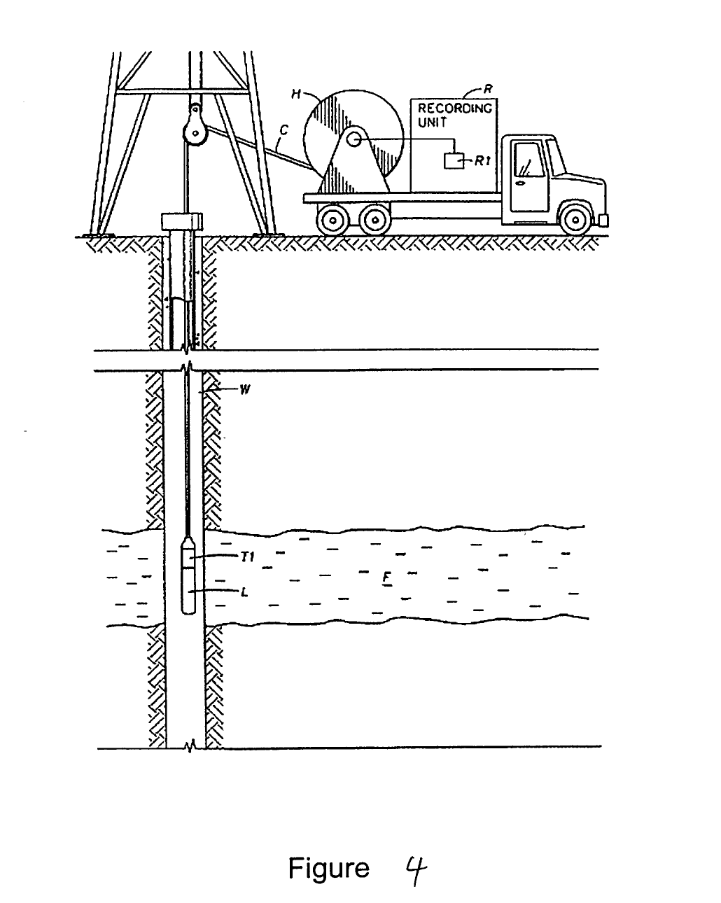

FIGS. 5a and 5b are schematic illustrations of the sub-bands used in the method of the present invention for two-way wireline communication with two different modes.

### DETAILED DESCRIPTION OF THE INVENTION

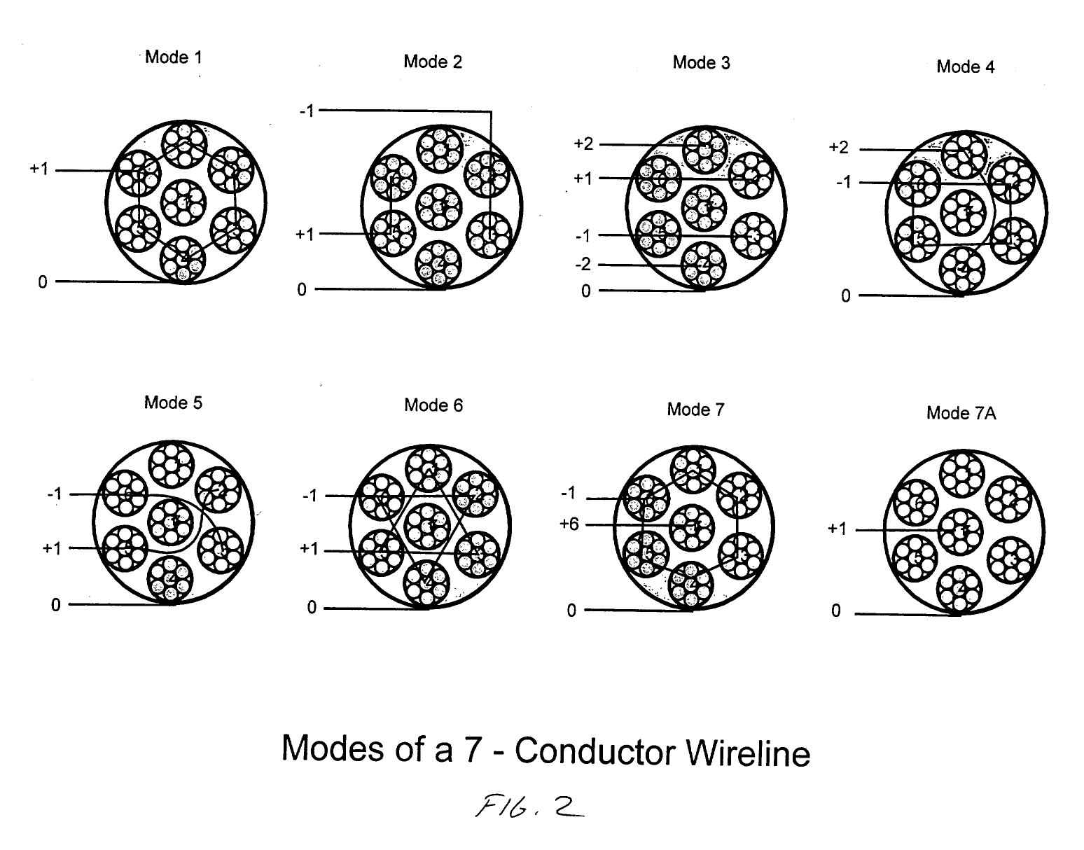

The method of a telemetry system according to the present invention can be better understood by referring to FIG. 2. A well logging tool L is lowered into a wellbore W penetrating an earth formation F. The logging tool L is attached to one end of an armored electrical cable C. The cable can be extended into the wellbore W by a hoist unit H, winch or similar device known in the art. The cable C is electrically connected to a recording unit R located at the earth's surface. The logging tool L can include a telemetry transmitter/receiver (transceiver) T1 for communicating signals generated by sensors (not shown) in the tool L and for receiving signals sent from the surface. The signals sent by the transceiver typically correspond to various properties of the earth formation F. A second transceiver T2 can be disposed within the recording unit R to receive and decode the signals transmitted from the logging tool L and to send signals to the logging tool L. The signals transmitted to the logging tool L typically comprise instructions for controlling the operation of the logging tool. The decoded signals at the surface can be converted into measurements corresponding to properties of the earth formation F. Instructions sent downhole are decoded by T1 to adjust the operation of the logging tool.

Two way communication between the surface transceiver T1 and the downhole transceiver T2 is accomplished in the present invention using a methodology that was developed for telephone lines. The Alliance For Telecommunications Information Solutions (ATIS), which is a group accredited by the ANSI (American National Standard Institute) Standard Group, has finalized a standard for the transmission of digital data over Asymmetric Digital Subscriber Lines (ADSL). The standard is intended primarily for transmitting video data over ordinary telephone lines, although it may be used in a variety of other applications as well. The standard is based on a discrete multi-tone transmission system. Transmission rates are intended to facilitate the transmission of information at rates of at least 6 million bits per second (i.e., 6+Mbps) over ordinary phones lines, including twisted-pair phone lines. The standardized discrete multi-tone (DMT) system uses 256 “tones” that are each 4.3125 kHz wide in the forward (downstream) direction. That is, in the context of a phone system, from the central office (typically owned by the telephone company) to a remote location that may be an end-user (i.e., a residence or business user).

The Asymmetric Digital Subscriber Lines standard also contemplates the use of a duplexed reverse signal at a data rate of at least 608 Kbps. That is, transmission in an upstream direction, as for example, from the remote location to the central office. Thus, the term Asymmetric Digital Subscriber Line in telephony comes from the fact that the data transmission rate is substantially higher in the forward direction than in the reverse direction. This is particularly useful in systems that are intended to transmit video programming or video conferencing information to a remote location over the telephone lines. By way of example, one potential use for the system allows residential customers to obtain video information such as movies over the telephone lines rather than having to rent video cassettes. Another potential use is in video conferencing.

In the U.S., maximum carrier service area ranges of 2 miles from a “central office” are typical when 24-gauge twisted pair wiring is used and 9000 feet is typical when 26-gauge wiring is used. Thus, one of the important features in the standardization process was that the selected system be capable of being transmitted throughout a CSA range from a central office over ordinary twisted-pair phone lines such as 24-gauge twisted pair phone lines. This requires both that the signal does not attenuate an unreasonably high amount and that it be relatively tolerant of cross-talk noise.

The method of the present invention is based upon the recognition that the distances involved and the cable sizes used in ADSL telephone communication are comparable to the distances and cable sizes in wireline logging. In the context of high speed wireline communication, the bulk of the data transmission is uphole from the logging tool whereas only a relatively small amount of data are transmitted from the surface transceiver T2 to the downhole transceiver T1. In addition, with a seven conductor wireline, as noted above, a plurality of modes is available. This is in contrast to telephone system wherein twisted pair wiring is used for communication. This provides additional flexibility to the method of communication of the data.

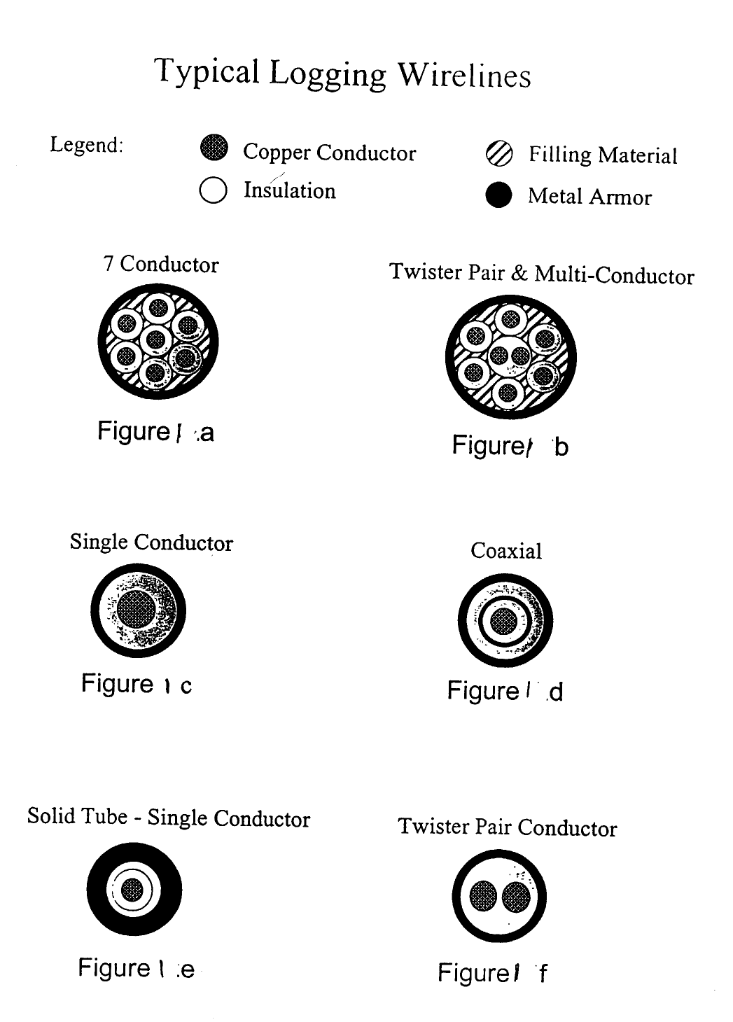

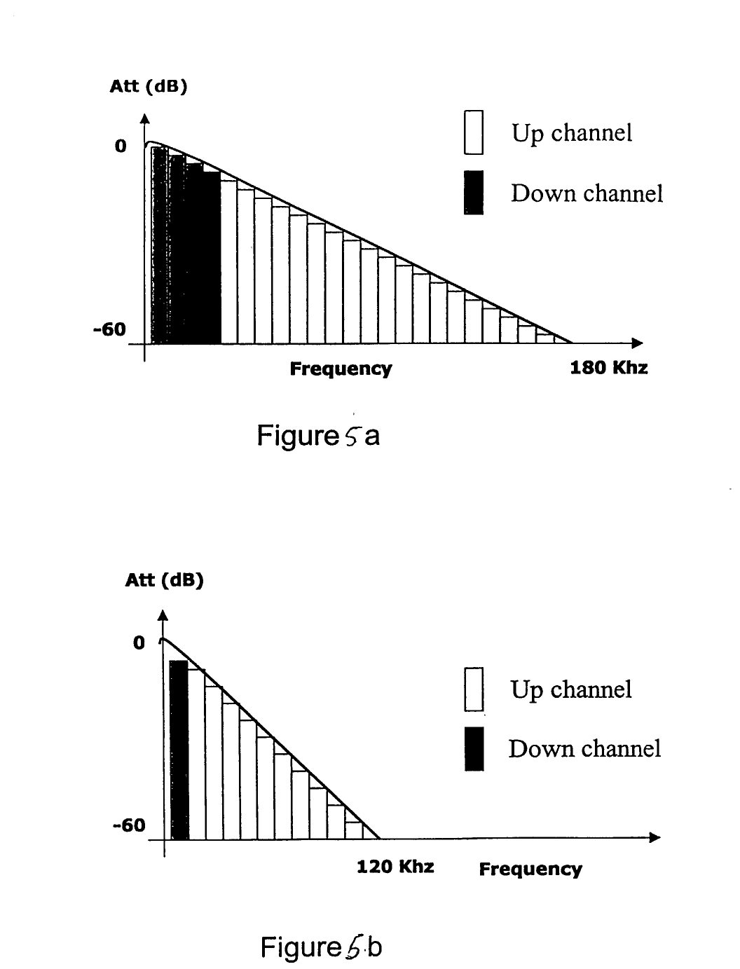

The method used in ADSL as used in the present invention is schematically illustrated in FIGS. 5a and 5b. Referring first to FIG. 5a, the line 121 depicts the attenuation characteristics of a particular mode for a particular length of a seven conductor cable. This may also depict the attenuation characteristics of any of the other types of cables shown in FIG. 1. It is of importance to note that the available bandwidth denoted by 100 is typically lower for wireline cables than those for telephone systems; i.e., a few hundred kHz compared to a few MHZ. This difference is attributed primarily to the size of the conductors.

As shown in FIG. 5a, the available bandwidth is subdivided into a plurality of sub-bands or channels. In normal operation, sub-bands (or channels) such as 101a, 101b, . . . are used for simultaneous transmission of data downhole while the remaining, larger number, of channels 103a, 103b, . . . 103i are used for transmission of data in the uphole direction. In the context of telephone communication and in the present application, this simultaneous transmission is commonly referred to as the full duplex mode. In contrast, for telephone communications, the lowest 26 kHz are used for voice transmission, the bandwidth from 26-300 kHz or so is used for uplink and 300 kHz to 1.4 MHz is used for downlink (from the central office).

It is preferable, as shown in FIG. 5a, that the channels used for downhole transmission be contiguous (as are the channels used for uphole transmission). This is not intended to be a limitation to the present application, but having the channels contiguous or adjacent in this manner makes the hardware and software design simpler and reduces the inter-channel interference. In the example shown in FIG. 5a, the higher frequency bands are designated for uphole communication, though this is not a limitation to the present invention. In fact, the present invention contemplates the possibility of switching the arrangements of the channels so that the higher frequency bands could be used for downhole communication while the lower frequencies are used for uphole communication.

FIG. 5b shows a similar partitioning when the available bandwidth is less. This may correspond to a different mode of the cable or may correspond to a longer length of the same cable as in FIG. 5a. Again, the number of channels for downward transmission 201a (one in this case) is less than the number of channels 203a, 203b . . . 203i used for upward data transmission.

In a preferred embodiment of the invention, the width of the channels is the same and is independent of the length of the cable and the mode of the cable. This simplifies the hardware that is used for data transmission over the individual sub-bands. In a preferred embodiment of the invention, the width of the sub-bands is the same as the ATIS standard of 4.3125 kHz. This makes it possible to reduce the cost of the apparatus by using standard off-the-shelf components. This limitation of equal width of the channels is not intended to be a limitation and, in alternate embodiments of the invention, the width of the channels could be different.

In a preferred embodiment of the invention, each channel uses Quadrature Amplitude Modulation (QAM) to carry 2² to 2¹⁵ bits/QAM symbol. This results essentially in overall performance which is equivalent to around fifty V.34 modems used in parallel on the same line. Because each channel can be configured to a different bit rate according to the channel characteristics, it can be seen that DMT is inherently “rate-adaptive” and extremely flexible for interfacing with surface and downhole equipment and line conditions. In typical DMT implementations, such as shown in U.S. Pat. No. 5,479,447 to Chow et. al., transmission power to the individual channels is initially configured based on the noise power and transmission loss in each band. In this way, channels with less noise and attenuation can carry larger amounts of data, while poorer channels can be configured to carry fewer bits and can even be shut down entirely. U.S. Pat. No. 5,596,604 to Cioffi et. al. shows that it is known to store relevant information for each DMT channel in a so called Bit & Energy Table. It is further known (U.S. Pat. No. 5,400,322 to Hunt et. al.) that line conditions can vary after initialization because of temperature fluctuations, interference, etc., and this can affect both the error rate and maximum data throughput. By measuring the quality of each sub-channel on an ongoing basis, in the present invention, an “updated” Bit & Energy Table is maintained to adaptively configure (dynamically modify) the system for maximum data throughput or error performance. In normal applications, if the quality of any particular channel degrades to the point where the error performance of the system is compromised, one or more bits on that channel are automatically moved to a channel that can support additional bits. For example, U.S. Pat. No. 6,134,273 to Wu et al, U.S. Pat. No. 6,128,348 to Kao et al and U.S. Pat. No. 6,084,906 to Chen et al disclose methods for determining the bit loading and dynamically modifying them.

Turning now to Table I, an example of the manner in which the communication may be carried out is shown.

TABLE I
Example of Data transmission with ADSL

| Group | # of channels | bits/symbol | symbols/sec. | capacity (kbits/s) |
|---|---|---|---|---|
| 1 | 4 | 2 | 4000 | 32 |
| 2 | 4 | 2 | 4000 | 32 |
| 3 | 4 | 4 | 4000 | 64 |
| 4 | 4 | 8 | 4000 | 128 |
| 5 | 4 | 8 | 4000 | 128 |
| 6 | 4 | 8 | 4000 | 128 |
| 7 | 4 | 8 | 4000 | 128 |
| 8 | 4 | 8 | 4000 | 128 |
| 9 | 4 | 16 | 4000 | 256 |

This table is for exemplary purposes only and shows that with a total of 36 channels, a data rate of 1.024 Mbits/s is possible. It does show that the number of bits/symbol is typically smaller in the higher frequencies and is larger at lower frequencies. As noted above, in a preferred embodiment of the invention, the number of bits per symbol may be varied depending upon a measured noise level in the channel.

Another aspect of the present invention is the ability, when using a 7 conductor wireline, to split the communication between the seven modes that are possible with a seven conductor cable. In a preferred embodiment of the invention, one or more of modes 2, 4, 5, 6 and 7 are used.

As would be known to those versed in the art, a number of problems have to be addressed in ADSL communications. An example of a method used for initialization is disclosed in U.S. Pat. No. 6,219,378 to Wu. One characteristic of most DSL systems, and ADSL in particular, is that the probability is high that each user link will operate in an “always on” or “always connected” mode. However, it is unlikely that any particular link will be in essentially constant use transmitting data. Thus, it is likely that a link will remain idle for extended periods of time during user inactivity and will transport blocks of data generated in bursts during user activity. During idle time, a number of problems occur if no data is transmitted over a connected link. Synchronization between a user's remote transceiver and a central office transceiver may be lost since no signal is being sent. This is addressed in the present invention. In a preferred embodiment of the invention, “null” data are repetitively transmitted during such idle periods. This makes it possible to avoid loss of synchronization, as well as makes it possible to monitor noise levels on the channels and maintain the dynamic adjustment of the bit loading on the individual channels. A particular example of such null data is disclosed in U.S. Pat. No. 6,052,411 to Mueller.

While the foregoing disclosure is directed to the preferred embodiments of the invention, various modifications will be apparent to those skilled in the art. It is intended that all variations within the scope and spirit of the appended claims be embraced by the foregoing disclosure.

What is claimed is:

1. A method of two way communication of data between a downhole logging tool in a borehole and an uphole device through a cable having at least one mode of communication therein, the method comprising, for the at least one mode:
(a) determining a range of frequencies available for communication;
(b) partitioning the range of frequencies into a plurality of non-overlapping sub-bands (channels);
(c) selecting a first contiguous subset of the plurality of channels and transmitting data from the uphole device in the first subset; and
(d) using a second contiguous subset of the plurality of channels distinct from the first plurality of channels for transmitting data from the logging tool to the uphole device.

2. The method of claim 1 wherein most of said plurality of channels have a bandwidth substantially equal to 4.3125 kHz.

3. The method of claim 1 wherein the first plurality of channels have a lower frequency than the second plurality of channels.

4. The method of claim 1 wherein the first plurality of channels have a higher frequency than the second plurality of channels.

5. The method of claim 1 wherein transmitting data in either (c) or (d) further comprises modulating a carrier signal at a center frequency of a channel with a modulating signal dependent upon the data being transmitted.

6. The method of claim 5 wherein transmitting the data further comprises selecting a number of symbols per unit time used in the modulating signal for any channel.

7. The method of claim 5 wherein transmitting the data further comprises selecting a number of bits per symbol used in the modulating signal for any channel.

8. The method of claim 6 wherein the selected number of symbols per unit time for a particular channel is in part dependent upon a measured noise level of the selected channel.

9. The method of claim 7 wherein the selected number of bits per symbol for a particular channel is in part dependent upon a measured noise level of the selected channel.

10. The method of claim 5 wherein said modulation further comprises a quadrature amplitude modulation (QAM).

11. The method of claim 1 further comprising an initialization prior to the transmitting of data.

12. The method of claim 1 wherein the data transmitted from the uphole device comprises command instructions for the logging tool.

13. The method of claim 1 wherein the data transmitted from the logging tool comprises measurements indicative or properties of earth formations surrounding the borehole, said measurements being made by at least one of: (i) an induction logging tool, (ii) a propagation resistivity logging tool, (iii) a density logging tool, (iv) a gamma ray logging tool, (v) a neutron logging tool, (v) a nuclear magnetic resonance tool, (vi) an acoustic logging tool, (vii) a resistivity imaging tool, and, (viii) an acoustic imaging tool.

14. The method of claim 1 wherein transmitting the data is done in a full duplex mode.

15. The method of claim 1 wherein the cable is a seven conductor wireline cable and the at least one mode further comprises modes 2, 4, 5, 6 and 7.

16. The method of claim 1 wherein the total rate of data transmission is over 500 kbits/s.

17. A method of two way communication of data between a downhole logging tool in a borehole and an uphole device through a cable having at least one mode of communication therein, the method comprising, for the at least one mode:
(a) determining a range of frequencies available for communication;
(b) partitioning the range of frequencies into a plurality of non-overlapping sub-bands (channels);
(c) selecting a first contiguous subset of the plurality of channels and transmitting data from the uphole device in the first subset;
(d) using a second contiguous subset of the plurality of channels distinct from the first plurality of channels for transmitting data from the logging tool to the uphole device; and
(e) at times when no data is being transmitted between the logging tool and the uphole device, transmitting null data therebetween for at least one of (i) maintaining synchronization between the logging tool and the uphole device, and, (ii) maintaining dynamic adjustment of a bit loading on the channels.

18. The method of claim 17 wherein at least one of the first and second subsets of said channels comprise a contiguous subset.

19 The method of claim 17 wherein transmitting data in either (c) or (d) further comprises modulating a carrier signal at a center frequency of a channel with a modulating signal dependent upon the data being transmitted.

20. The method of claim 19 wherein transmitting the data further comprises selecting a number of symbols per unit time used in the modulating signal for any channel.

21. The method of claim 19 wherein said modulation further comprises a quadrature amplitude modulation (QAM).

22. The method of claim 17 wherein the data transmitted from the logging tool comprises measurements indicative or properties of earth formations surrounding the borehole, said measurements being made by at least one of: (i) an induction logging tool, (ii) a propagation resistivity logging tool, (iii) a density logging tool, (iv) a gamma ray logging tool, (v) a neutron logging tool, (v) a nuclear magnetic resonance tool, (vi) an acoustic logging tool, (vii) a resistivity imaging tool, and, (viii) an acoustic imaging tool.

23. The method of claim 17 wherein transmitting the data is done in a full duplex mode.

24. The method of claim 17 wherein the cable is a seven conductor wireline cable and the at least one mode further comprises modes 2, 4, 5, 6 and 7.
